(19) United States
(12) Patent Application Publication
(10) Pub. No.: US 2013/0228264 A1
(43) Pub. Date: Sep. 5, 2013

(54) Devices, Systems and Methods for Identifying and Tracking Luggage

(71) Applicant: Patrick J. Fitzsimmons, Erie, PA (US)

(72) Inventor: Patrick J. Fitzsimmons, Erie, PA (US)

(21) Appl. No.: 13/602,795

(22) Filed: Sep. 4, 2012

Related U.S. Application Data
(60) Provisional application No. 61/530,950, filed on Sep. 3, 2011.

(51) Int. Cl. B32B 37/00; B32B 37/06

(52) U.S. Cl. CPC G06Q 10/0833; B32B 37/06
USPC 156/64; 156/583.1; 156/60; 156/277

(57) ABSTRACT

A device, method and system for tracking luggage is shown. The invention includes a vinyl heat transfer affixing device for permanently affixing an identifying customized picture or tracking device to luggage. The invention also includes a system and method for a customer to choose the type, size, and location of the identifying picture, as well as choose the type of luggage to which the picture will be affixed. The invention also includes a system and method for a finder of lost luggage to alert the luggage owner as to the luggage's location, without requiring the owner's identity, phone number or physical address.

### CROSS REFERENCE TO RELATED APPLICATIONS

This application claims the benefit of provisional Application 61/530,950, filed Sep. 3, 2011, and which is incorporated by reference herein.

### BACKGROUND AND SUMMARY OF THE INVENTION

Lost or hard to identify luggage is a constant anxiety for travelers.

The common shapes and colors of luggage make it very likely for two persons on the same flight or trip to have similar or identical luggage, resulting in mix-ups with one traveler accidentally taking another traveler's luggage. Also, airport thieves take advantage of the fact that much luggage looks similar, and will boldly grab luggage that does not belong to them, knowing they can claim that they made an innocent mistake and meant to take their “own” luggage.

Luggage often does not reach its correct destination, and reuniting luggage with its owner can be a difficult or impossible task. The luggage may have no owner contact information, or the contact tag may have torn off during transit. Also, it is quite common that the contact information may only provide the owner's home address and be of little or no use to the transportation agency or other finder attempting to contact the owner when the owner is at another destination. The contact information with the owner's home address also reveals to unscrupulous persons that the homeowner is away and the home may be unguarded during the homeowner's trip.

Travelers commonly try to identify luggage by tying ribbons or attaching various pieces of tape on luggage. These identification methods are only partially effective because the identifying ribbons or pieces of tape put on luggage may fall off during inspection or transit, or might be too similar to another traveler's luggage identification, or may not be noticeable enough to prevent another traveler from accidentally taking the luggage.

A solution for luggage identification would be to affix a large customized picture (for example the owner's face) to the luggage. However, ordinary hot platens that affix vinyl heat transfers to shirts will not affix a decal to luggage, because ordinary heat presses are not designed to fit a piece of luggage between the platens, and luggage is typically made of a material that will resist a vinyl heat transfer being permanently affixed to the luggage.

Therefore, there exists a need for permanently affixing to luggage a unique identifier that allows the luggage owner to easily identify the luggage and warn other travelers that the luggage is not theirs. In the event the luggage is lost, there exists a need for permanently or temporarily affixing a tracking means to luggage that allows the luggage finder to contact the luggage owner while preserving the luggage owner's anonymity.

Accordingly, it is an objective of the present invention to provide a system for luggage identification and tracking to meet those needs.

It is an objective of the present invention to provide a method for visually identifying and distinguishing an owner's luggage from other travelers' luggage.

It is another objective of the present invention to provide a device and method for permanently adhering visual identification for luggage directly onto luggage fabric.

It is another objective of the present invention to provide a device and means for a finder of lost luggage to contact the owner of the luggage while protecting the anonymity of the luggage owner.

It is another objective of the present invention to provide a device and method for permanently adhering a tracking means to luggage.

It is another objective of the present invention to allow luggage purchasers to visually uniquely customize their luggage.

An embodiment of the invention and its parts are drawn for the devices and method for identifying and tracking luggage. A part of an embodiment includes a novel luggage press and method for use that allows for permanently affixing a customized picture to ordinary luggage.

The invention also includes a tracking system where a tracking number or barcode is affixed to a luggage tag or permanently affixed to the luggage. The luggage tag or luggage picture also lists a website that the finder of the luggage may go to, to enter in the luggage tracking number and the finder's contact information. The barcode or tracking number is associated with the luggage owner's email address and cell phone number for text messaging. When the tracking number is entered into the website, an email and text is sent to the luggage owner with the finder's contact information.

“Luggage” as used herein is meant in the broadest sense and includes any travel container, for example, gym bags, boxes, duffel bags, computer cases, briefcases, and so on. The devices, systems and methods here are applicable to luggage as herein defined with modifications that are obvious to those skilled in the art.

### DRAWINGS

FIG. 1 is a side view of an embodiment of a luggage press.

FIG. 2 is a front view of the luggage press of FIG. 1.

FIG. 3 is the side view of FIG. 1, with reference numerals omitted and dimensions of the embodiment given in inches.

FIG. 4 is the front view of FIG. 2, with reference numerals omitted and dimensions of the embodiment given in inches.

FIG. 5 is a top view of the luggage press of FIG. 1, with reference numerals omitted and dimensions of the embodiment given in inches.

FIG. 6 is a perspective view of the luggage press of FIG. 1.

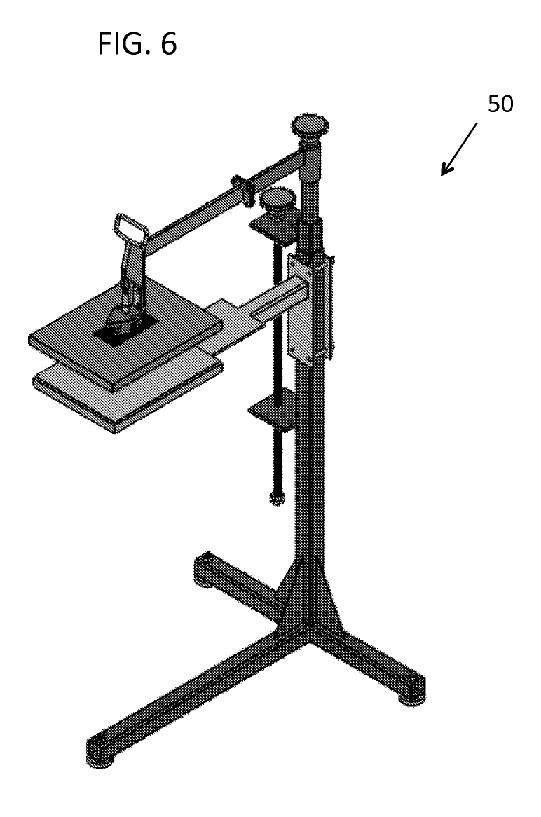

FIG. 7 is a flow chart of a portion of an embodiment of the invention, for permanently affixing a picture to luggage.

FIG. 8 is a flow chart of a portion of an embodiment of the invention, for tracking lost luggage.

FIG. 9 is a flow chart of a portion of an embodiment of the invention, namely, a second method for tracking lost luggage.

### DETAILED DESCRIPTION

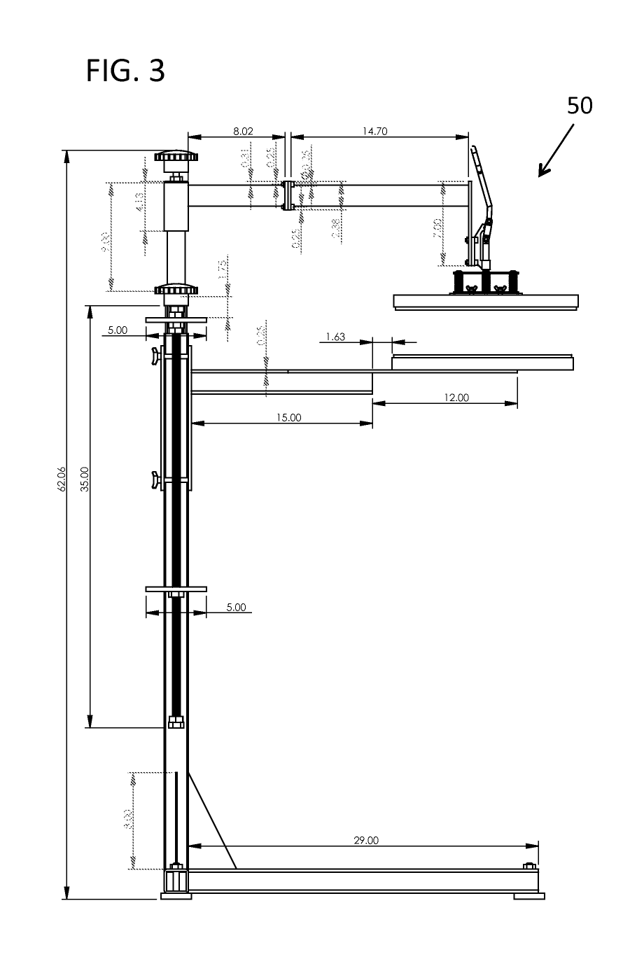

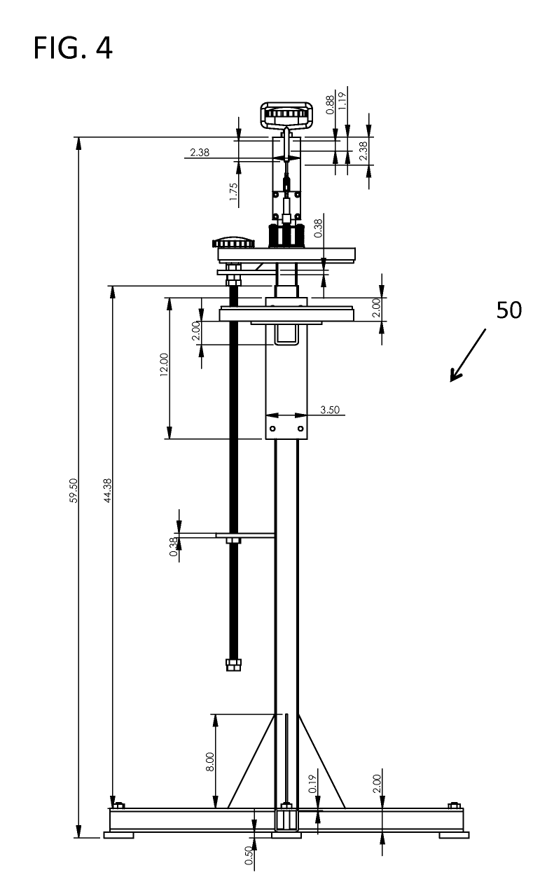

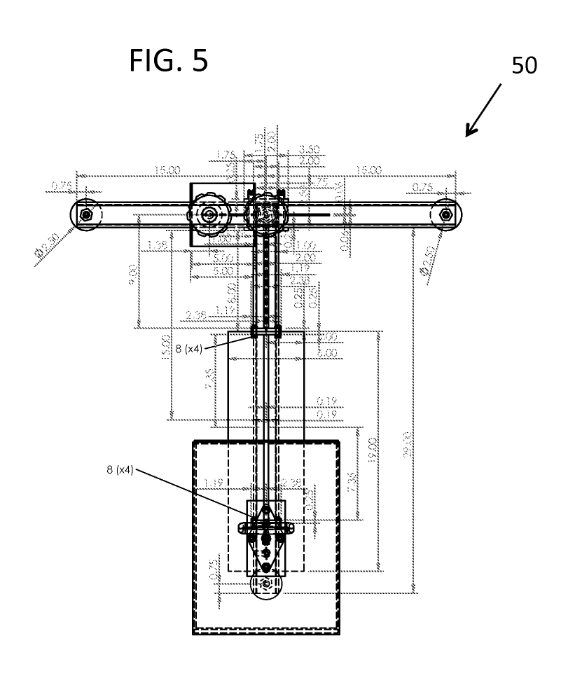

Precise measurements of this embodiment of the luggage press 50 are given in FIGS. 3, 4 and 5 in order to show how a luggage press may be sized to efficiently accommodate various standard luggage sizes and press vinyl heat transfers onto various places on luggage. Each of these measurements of luggage press 50 may be modified without sacrificing the functionality of the luggage press 50, as will be obvious to those with ordinary skill in the art.

Luggage press 50 allows for vinyl heat transfers to be permanently affixed to luggage. With this embodiment of a luggage press 50, a decal can be permanently affixed to ordinary luggage when the decal is pressed, for example, for approximately 15-25 seconds with approximately 35-45 pounds of pressure when the upper heat platen 9 is at approximately 176 degrees centigrade.

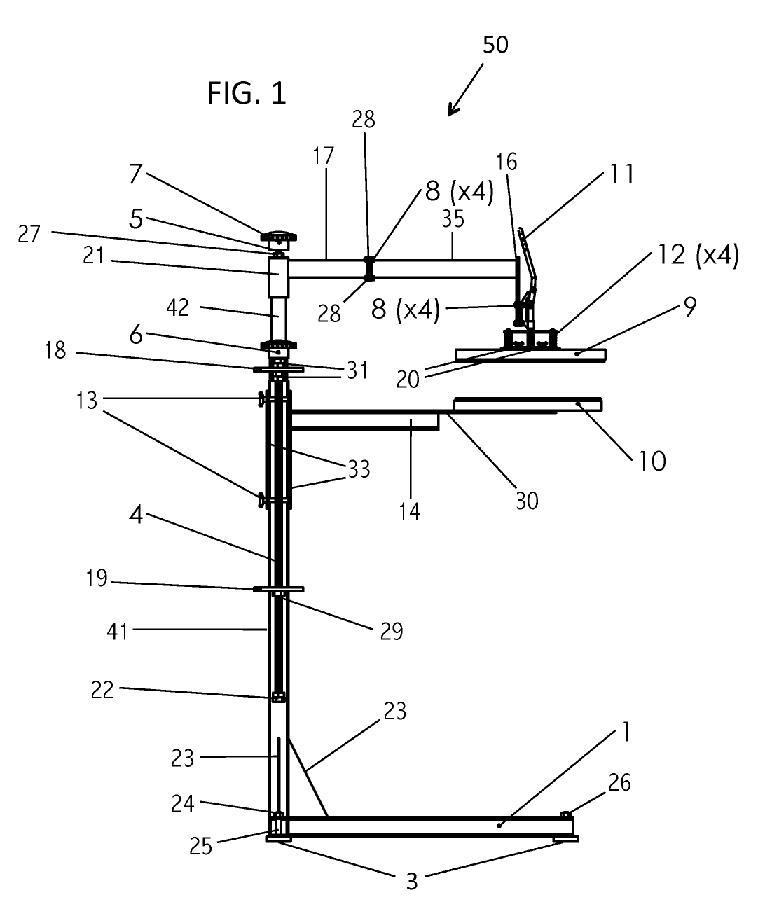

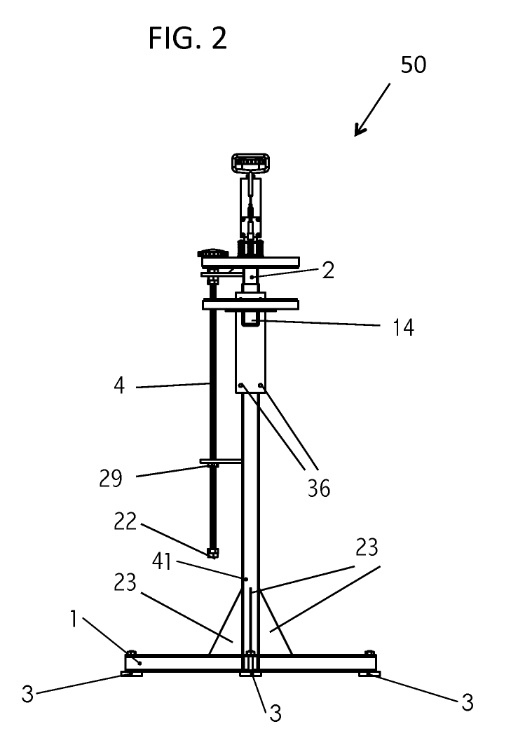

Looking now at FIGS. 1, 2, at 6, in this embodiment of the luggage press 50, support feet 3 are attached to the bottom of support legs 1. Bolts 25 attached to support feet 3 go though holes (not shown) in support legs 1 and support leg nuts 26 and 24 fasten support feet 3 to support legs 1.

Lower square steel tubing 41 at base of luggage press 50 is supported by steel braces 23 that are welded or otherwise affixed to support legs 1 and lower square steel tubing 41.

Tubular steel extension 14 is affixed or welded to one of steel plate adjusters 33 and affixed or welded to steel plate 30. Alternatively tubular steel extension 14 and steel plate 30 are manufactured as one piece. Lower platen 10 is affixed or welded to steel plate 30.

Steel plate adjusters 33 are pressed together against opposite sides of lower square steel tubing 41 with tightened bolts 36 and wing nuts 33. Loosening of wing nuts 33 allows for steel plate adjusters to separate and move up or down square steel tubing 41, thus allowing lower platen 10 to raise or lower.

Circular steel tubing 42 is welded or otherwise affixed to upper square steel tubing 2. Upper square steel tubing 2 is slidable within lower square steel tubing 41. Upper steel plate 18 is welded or otherwise affixed to upper square steel tubing 2 and lower steel plate 19 is welded or otherwise affixed to lower square steel tubing 41. Height threaded rod 4 runs through upper steel plate 18 and lower steel plate 19. Threaded nuts 31 on height threaded rod 4 sandwich upper steel plate 18, and threaded nut 29 is directly below lower steel plate 19. Height adjustment knob 6 is affixed to height threaded rod 19.

Steel bar 17 is welded or otherwise affixed to steel sleeve 21. Steel bar 17 is attached to steel bar 35 with steel plates 28 containing apertures (not shown) wherein the steel plates are held together with bolts and nuts 8 in the apertures (not shown).

Steel drop plate 16 is welded or otherwise affixed to steel bar 35. Nuts and bolts 8 attach steel drop plate 16 to handle apparatus 11 for upper heat platen 9. Wingnuts 20 attached handle 11 to upper heat platen 9. Pulling handle apparatus 11 pushes upper heat platen 9 towards lower platen 10. Pressure springs 12 are attached to handle apparatus 11 and return upper heat platen 9 to a raised position.

Steel sleeve 21 contains threaded female receptor (not shown), and counterpart threaded bolt 5 is inside. Steel sleeve 21 rests on circular steel tubing 42. Pivot adjustment knob 7 is attached to threaded bolt 5. When adjustment knob 7 is loosened, upper head platen 9 may rotate freely.

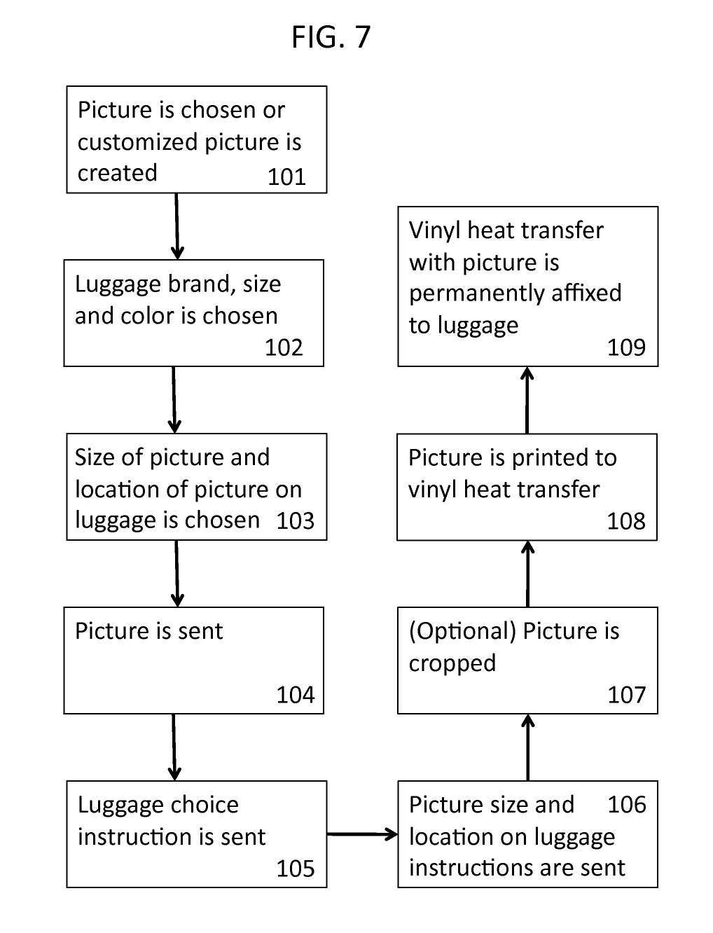

Looking now at FIG. 7, a method and system for customizing a display on luggage is shown. A luggage purchaser chooses a picture, possibly the purchaser's own or from a pre-selected number of pictures offered by a luggage customizer. 101. The luggage purchaser then chooses what brand, size, and color of luggage the purchaser wants to buy. 102. The choice of luggage can also be offered by the luggage customizer, for example on the luggage customizer's website. The purchaser then sends the picture to the luggage customizer, 104, for example by email, and the purchaser also send an instruction, for example by email or performing operations on an interactive website, as to the choice of luggage. 105. The purchaser also send instructions, for example by email or interactive website, as to the size of the picture and where on the luggage the picture will be affixed. 106. As an option, the luggage customizer may suggest cropping the picture to the appropriate dimension to properly fill a preselected portion of the luggage surface. 107. The picture is then printed onto a vinyl heat transfer. 108. The vinyl heat transfer is then permanently affixed to the luggage that was selected by the purchaser, in the location selected by the purchaser. 109. The vinyl heat transfer process may be performed, for example, by the embodiment of the luggage press 50 described above.

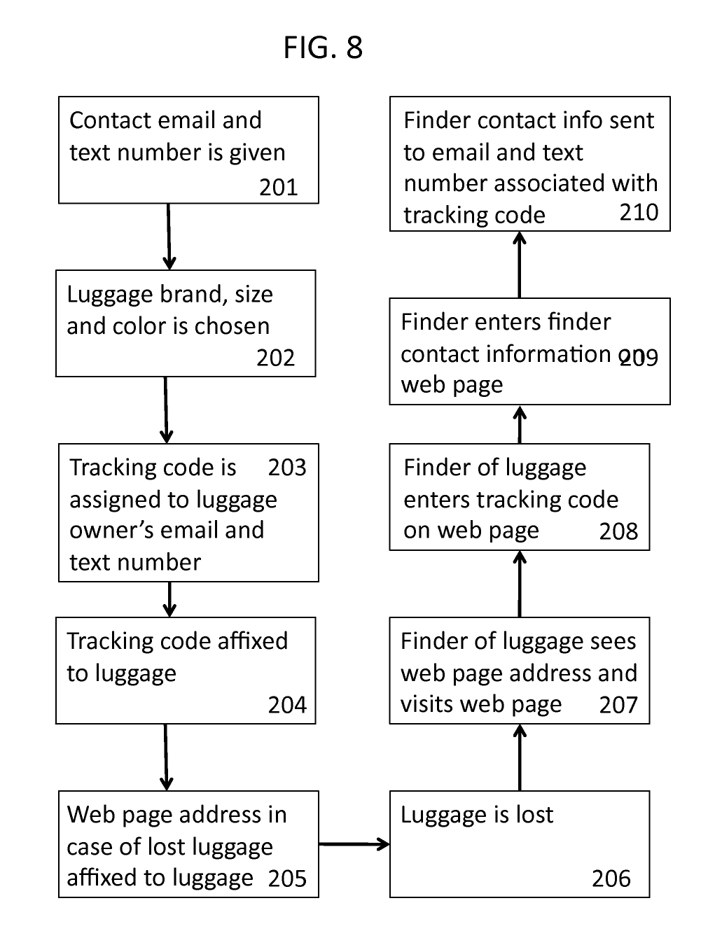

Looking now at FIG. 8, a method and system for tracking lost luggage is shown. A traveler orders customized luggage from, for example, a business that specializes in customizing luggage. The traveler gives the business the traveler's contact email and cell phone number for texting. 201. The traveler then chooses, on the business website for example, what type of luggage he or she wants to customize. 202. The customizing business assigns a tracking code, for example a combination of letters and numbers, to the contact email and cell phone. 203. Using the luggage press 50 or some other device or method, the tracking code is affixed to the luggage. 204. In addition, a web page address is also affixed to the luggage, notifying any finder of the luggage to visit the web page in order to help the luggage owner (e.g., the traveler) retrieve the luggage. 205.

When the luggage is lost, 206, the finder of the luggage will read the notice on the luggage to visit the webpage to help the owner retrieve the luggage. 207. The finder then visits the web page, 207, and enters the tracking code on the web page. 208. The finder also enters the finder's personal contact information in to give the luggage owner the ability to contact the luggage finder. 209.

When the tracking code is entered into the web page, an email and text message is sent to the luggage owner, notifying the luggage owner that the owner's luggage has been found. The contact information of the finder is also sent to the luggage owner. 210.

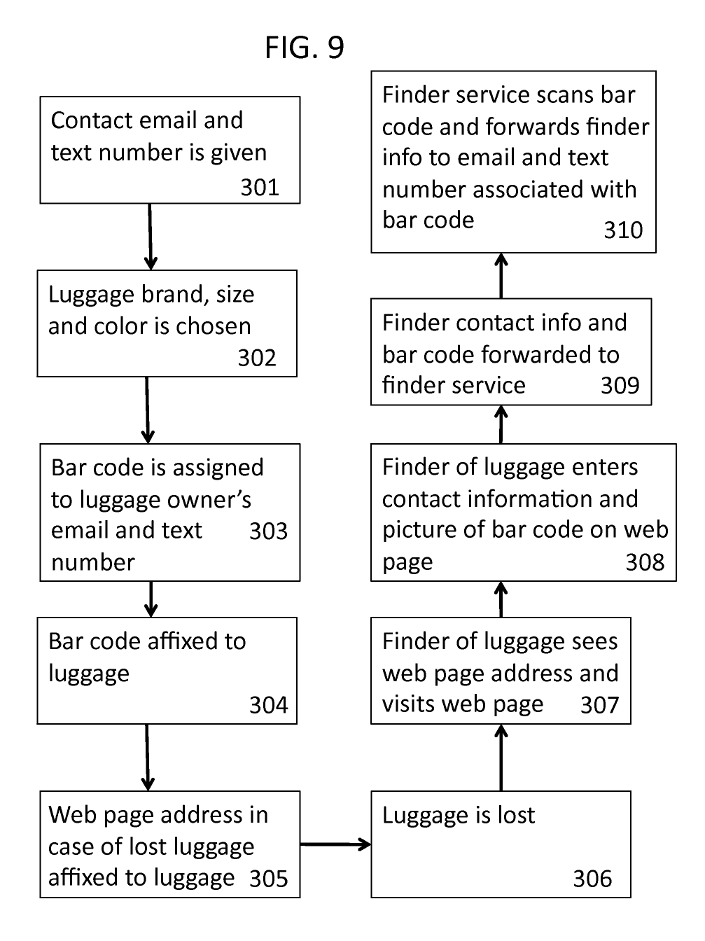

Looking now at FIG. 9, an alternative or backup method and system to FIG. 8 for tracking lost luggage is shown, namely, a bar code is affixed to the luggage instead of (or in addition to) a tracking code, wherein the bar code is assigned to an email and cell number for text messaging. When the luggage is lost, 306, the finder visits the web page displayed on the luggage 307 and enters the finder's contact information and a picture of the bar code onto the web page. 308. The picture of the bar code is then forwarded to the luggage finder service 309, which is able to scan the bar code, identify the owner's email associated therewith, and notify the luggage owner that the luggage has been found. 310.

Various changes, alternatives and modifications will become apparent to one of ordinary skill in the art following a reading of the foregoing specification. It is intended that any such changes, alternatives and modifications as fall within the scope of the appended claims be considered part of the present invention.

1. (canceled)

2. A device for affixing a vinyl heat transfer to luggage, comprising:
a vertical stand, an upper arm, a lower arm, an upper platen, and a lower platen;
wherein said upper arm is affixed perpendicular to said stand, and wherein said upper platen is affixed to said upper arm;
wherein said lower arm is affixed perpendicular to said stand, and wherein said lower platen is affixed to said lower arm;
a means to heat said upper platen;
wherein said device is operable to align and affix said upper platen and said lower platen in a superposed alignment; and
wherein said device is operable to press said upper platen against said lower platen.

3. The device of claim 1, wherein the shortest distance between said lower platen and said stand is at least 15 inches.

4. The device of claim 1, wherein the shortest distance between said lower platen and said stand is at least 10 inches.

5. The device of claim 1, wherein said device is operable to position and affix said upper platen and said lower platen in a completely non-superposed alignment.

6. The device of claim 1, further comprising a means to raise or lower said lower platen to a new fixed height.

7. The device of claim 1, further comprising a means to raise or lower said upper platen to a new fixed height.

8. The device of claim 1, further comprising a base, wherein said base is affixed to said stand, and wherein said base includes a leg, and wherein said leg of said base is vertically aligned parallel with said lower arm, and wherein the greatest distance between said leg and said stand is greater than the greatest distance between said lower arm and said stand.

9. The device of claim 1, wherein the shortest distance between said upper arm and said lower arm is greater than the shortest distance between said upper platen and said lower platen.

10. A method for affixing a vinyl heat transfer to luggage with the device of claim 1, comprising:
opening said luggage;
placing a side of said luggage on said lower platen;
placing a vinyl heat transfer on the top of said side of said luggage;
superposing said upper platen above said lower platen, wherein said vinyl heat transfer is between said luggage and said upper platen;
heating said upper platen to approximately 176 degrees centigrade; and
pressing said upper platen against said vinyl heat transfer with approximately 35 to 45 pounds of pressure for approximately 35 to 55 seconds.

11. A method for affixing a vinyl heat transfer to a luggage surface, said method comprising:
pressing with a pressing device said vinyl heat transfer to said luggage surface with 35 to 45 pounds of uniform pressure for 35 to 55 seconds;
wherein the surface of the pressing device in contact with the vinyl heat transfer has a temperature of 176 degrees centigrade.

12. A method for affixing a customized picture to luggage, said method comprising:
providing a means for a customer to a choose a picture;
providing a means for said customer to choose a luggage preference;
providing a means for said customer to choose the size of said picture;
providing a means for said customer to choose a location on said luggage for said picture;
providing a means for said customer to transmit said picture, said luggage preference, said picture size, and said location on said luggage;
printing said picture to a vinyl heat transfer; and
permanently affixing to said luggage said picture in said size at said location, using the method of claim 11.

13. A method for tracking a luggage owner's lost luggage, said method comprising:
affixing a tracking code to said luggage, wherein said tracking code is assigned to a specific email or a specific phone number;
affixing a web page address to said luggage;
said luggage owner losing said luggage;
a luggage finder finding said luggage;
said luggage finder entering said web page address into a computer browser;
said luggage finder entering said tracking code into said web page; and
said luggage finder entering said luggage finder's contact information into said web page,
wherein said luggage finder's contact information is sent to said luggage owner via said specific email or said specific phone number.

14. The method of claim 13, wherein said tracking code is a bar code, and wherein said luggage finder enters said tracking code into said web page by taking a picture of said bar code and uploading said picture to said web page.

15. The method of claim 13, wherein affixing said tracking code to said luggage further comprises:
printing an image to the front of a luggage tag;
imprinting a unique personalized bar code to the rear of said luggage tag;
capturing said unique personalized bar code in a data base for future tracking and notifications to a customer; and
affixing said luggage tag to said luggage.

16. A method for affixing a vinyl heat transfer to luggage with the device of claim 1, comprising:
opening said luggage;
placing a side of said luggage on said lower platen;
placing a vinyl heat transfer on the top of said side of said luggage;
superposing said upper platen above said lower platen, wherein said vinyl heat transfer is between said luggage and said upper platen;
heating said upper platen to approximately 176 degrees centigrade; and pressing said upper platen against said vinyl heat transfer with approximately 35 to 45 pounds of pressure for approximately 15 to 25 seconds.

17. A method for affixing a vinyl heat transfer to luggage with the device of claim 1, comprising:
opening said luggage;
placing a side of said luggage on said lower platen;
placing a vinyl heat transfer on the top of said side of said luggage;
superposing said upper platen above said lower platen, wherein said vinyl heat transfer is between said luggage and said upper platen;
heating said upper platen to approximately 176 degrees centigrade; and
pressing said upper platen against said vinyl heat transfer with approximately 35 to 45 pounds of pressure for more than 20 seconds.
